(19) United States
(12) Patent Application Publication
(10) Pub. No.: US 2026/0005312 A1
(43) Pub. Date: Jan. 1, 2026

(54) NON-AQUEOUS ELECTROLYTE CONTAINING TIN SALT OR GERMANIUM SALT AND SECONDARY BATTERY EMPLOYING SAME

(71) Applicant: DAEGU GYEONGBUK INSTITUTE OF SCIENCE AND TECHNOLOGY, Dalseong-gun, Daegu (KR)

(72) Inventors: Hochun LEE, Daegu (KR); Jong Won PARK, Gwangju-si (KR)

(73) Assignee: DAEGU GYEONGBUK INSTITUTE OF SCIENCE AND TECHNOLOGY, Dalseong-gun, Daegu (KR)

(21) Appl. No.: 18/879,330

(22) PCT Filed: Jun. 15, 2023
(86) PCT No.: PCT/KR2023/008283

§ 371 Date: Dec. 27, 2024

(30) Foreign Application Priority Data
Jun. 28, 2022 (KR) 10-2022-0078799

(51) Int. Cl. H01M 10/0568; H01M 10/0567; H01M 10/0569

(52) U.S. Cl. CPC H01M 10/0568; H01M 10/0567; H01M 10/0569

(57) ABSTRACT

The present invention relates to a non-aqueous electrolyte for secondary batteries, wherein the electrolyte includes a tin salt or a germanium salt, an electrolyte salt, and a non-aqueous organic solvent. A secondary battery employing same can exhibit significantly enhanced performance under extreme conditions such as rapid charge/discharge, high-temperature storage, and high-temperature charge/discharge.

### TECHNICAL FIELD

The present invention relates to a non-aqueous electrolyte for a secondary battery including a tin salt or a germanium salt and a secondary battery employing the same.

### BACKGROUND ART

A secondary battery using a non-aqueous electrolyte mainly uses a transition metal oxide-based positive electrode material represented by AₐM_{b}O_{c} (A=Li, Na, Mg, M=Co, Ni, Mn) and a negative electrode material such as natural graphite, artificial graphite, hard carbon, silicon, and silicon oxides. The positive electrode materials and the negative electrode materials are unlikely to deteriorate under typical charging and discharging conditions of secondary batteries, but undergo accelerated deterioration when exposed to a high temperature of 55° C. or higher or under extreme conditions such as fast charging and discharging and long-term charging and discharging.

One of the main causes of the secondary battery deterioration is a decomposition reaction of solid electrolyte interphase (SEI) of a negative electrode. Numerous previous studies suggested a method of using a functional electrolyte additive for improving the characteristics of a negative electrode SEI. A representative electrolyte additive includes vinylene carbonate (VC), 3-fluoro ethylene carbonate (FEC), 1,3-propane sultone (PS), and the like. When the additive is included, an effect of improving a battery life is shown by improving the durability of SEI, but high electrical resistance is shown, so that the output characteristics of a battery are decreased.

The structural collapse of the positive electrode material is also the main cause of the secondary battery deterioration. In particular, as a result of a side reaction between a positive electrode and an electrolyte, metal ions such as Mn, Co, and Ni which are dissolved products of the positive electrode material, or acid and radical components which are electrolyte decomposition products occur, and the by-products move to a negative electrode and cause negative electrode deterioration, thereby accelerating deterioration of secondary battery performance.

In order to suppress deterioration of battery performance due to the side reaction between the positive electrode material and the electrolyte, two methods are largely applied. First, a method of coating a surface of a positive electrode material is used. The method limits physical contact between a positive electrode material and an electrolyte by coating the surface of the positive electrode material with an inactive inorganic material, for example, Al₂O₃, AlPO₄, ZnO, and the like. However, the method increases manufacturing process costs of the positive electrode material and deteriorates the output characteristics of a secondary battery by an inorganic coating layer which acts as a resistant layer interfering with charge transfer.

A second method is using a functional electrolyte additive, and the functional electrolyte additive is known to form a cathode electrolyte interphase (CEI) which is a protective membrane similar to SEI on the surface of the positive electrode and serve to form a complex of metal ions eluted from the positive electrode material and chemically remove acid components included in the electrolyte. The method of using an electrolyte additive has a low possibility of increasing process costs as compared with the method of coating the surface of a positive electrode, but the additives which have been reported in the previous documents have a problem of being electrochemically oxidized or reduced themselves and decomposed or a demerit of an insufficient improvement effect. Therefore, an electrolyte additive having excellent performance which may effectively improve a side reaction between a positive electrode material and an electrolyte without showing the problem of being decomposed as described above is needed.

### DISCLOSURE

### Technical Problem

An object of the present invention is to provide a non-aqueous electrolyte for a secondary battery which includes a tin salt or a germanium salt to form a protective membrane on surfaces of a positive electrode material and a negative electrode material.

Another object of the present invention is to provide a secondary battery having improved battery durability by including the tin salt or the germanium salt.

### Technical Solution

In one general aspect, a non-aqueous electrolyte for a secondary battery includes: a tin salt or a germanium salt represented by the following Chemical Formula 1; an electrolyte salt; and a non-aqueous organic solvent:

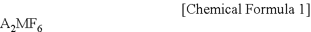

wherein
M is Sn or Ge; and
A is Li, Na, K, or NH₄.

The tin salt may be represented by the following Chemical Formula 2:

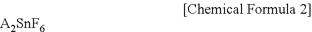

wherein
A is Na, K, or NH₄.

In addition, the germanium salt may be represented by the following Chemical Formula 3:

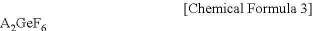

wherein
A is Li, Na, K, or NH₄.

The non-aqueous electrolyte for a secondary battery according to an exemplary embodiment may further include a silicon salt represented by the following Chemical Formula 4:

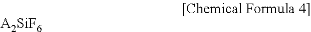

wherein
A is Li, Na, K, or NH₄.

In addition, the tin salt or the germanium salt according to an exemplary embodiment may be included at 0.01 to 1 wt % based on the total amount of the electrolyte.

The electrolyte salt according to an exemplary embodiment of the present invention may be one or two or more selected from LiPF₆, LiBF₄, LiSbF₆, LiAsF₆, LiCF₃SO₃, LiC₄F₉SO₃, LiClO₄, LiAlCl₄, LiN(CₓF₂ₓ₊₁SO₂)₂ (x is an integer of 0 or more), LiCl, and LiI, and a concentration of the electrolyte salt may be 0.5 to 3 mol/L.

The non-aqueous organic solvent according to an exemplary embodiment may one or two or more selected from propylene carbonate, ethylene carbonate, butylene carbonate, diethyl carbonate, dimethyl carbonate, methyl ethyl carbonate, γ-butyrolactone, γ-valerolactone, ethyl acetate, methyl propionate, tetrahydrofuran, 2-methyltetrahydrofuran, dioxane, dimethoxyethane, diethyl ether, dimethyl sulfoxide, dimethyl sulfone, and sulfolane.

In addition, the non-aqueous electrolyte for a secondary battery may further include one or two or more additives selected from cyclohexylbenzene, biphenyl, t-butylbenzene, vinylene carbonate, vinyl ethylene carbonate, difluoroanisole, fluoroethylene carbonate, propanesultone, dimethyl vinylene carbonate, and succinonitrile.

In another general aspect, a secondary battery includes: a first electrode; a second electrode; and the non-aqueous electrolyte for a secondary battery according to an exemplary embodiment interposed between the first electrode and the second electrode.

The first electrode and the second electrode according to an exemplary embodiment of the present invention may be a lithium electrode.

### Advantageous Effects

A non-aqueous electrolyte for a secondary battery including a tin salt or a germanium salt of the present invention forms a CEI and an SEI which are protective membranes on a surface of a positive electrode material and a negative electrode material when being dissolved in a solvent, and a secondary battery including the non-aqueous electrolyte for a secondary battery may have significantly improved performance by suppressing a deterioration phenomenon of the positive electrode material caused by exposure to extreme conditions such as fast charge/discharge, high-temperature storage, and high-temperature charge/discharge.

In addition, the secondary battery employing the non-aqueous electrolyte for a secondary battery including the tin salt or the germanium salt of the present invention does not cause deterioration of output characteristics and may have surprisingly improved durability under high temperature conditions, as compared with conventional additives.

### DESCRIPTION OF DRAWINGS

FIG. 1 is a drawing which shows results of analyzing interfacial resistances of Examples 1 to 3 and Comparative Examples 1 and 2, using an electrochemical impedance spectrometric (EIS) instrument.

FIG. 2 is a drawing which shows results of evaluating the output characteristics of Examples 1 to 3 and Comparative Examples 1 and 2.

### BEST MODE

Hereinafter, a non-aqueous electrolyte for a secondary battery including a tin salt or a germanium salt of the present invention and a secondary battery employing the same will be described in detail.

The singular form used in the present invention may be intended to also include a plural form, unless otherwise indicated in the context.

In addition, the numerical range used in the present invention includes all values within the range including the lower limit and the upper limit, increments logically derived in a form and span in a defined range, all double limited values, and all possible combinations of the upper limit and the lower limit in the numerical range defined in different forms. Unless otherwise defined in the specification of the present invention, values which may be outside a numerical range due to experimental error or rounding off of a value are also included in the defined numerical range.

The term “comprise” described in the present invention is an open-ended description having a meaning equivalent to the term such as “is/are provided”, “contain”, “have”, or “is/are characterized”, and does not exclude elements, materials or processes which are not further listed.

Hereinafter, the present invention will be described in detail. Here, technical terms and scientific terms used in the present specification have the general meaning understood by a person skilled in the art unless otherwise defined, and a description for the known function and configuration obscuring the present invention will be omitted in the following description.

The present invention provides a non-aqueous electrolyte for a secondary battery including: a tin salt or a germanium salt represented by the following Chemical Formula 1; an electrolyte salt; and a non-aqueous organic solvent:

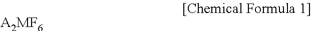

wherein
M is Sn or Ge; and
A is Li, Na, K, or NH₄.

The non-aqueous electrolyte for a secondary battery including the tin salt or the germanium salt represented by Chemical Formula 1 may significantly improve performance of a secondary battery, and in particular, may show minimization of the deterioration phenomenon of the positive electrode material and have surprisingly improved durability at a high temperature.

Though the clear mechanism for the improvement of the deterioration phenomenon of the positive electrode material due to the non-aqueous electrolyte for a secondary battery of the present invention was not identified, it is considered that the tin salt or the germanium salt represented by Chemical Formula 1 forms a coat on the surface of a positive electrode or a negative electrode to prevent decomposition of the non-aqueous electrolyte by oxidation and reduction and suppress a deterioration phenomenon which may arise therefrom, thereby improving the durability at a high temperature of a secondary battery.

The tin salt according to an exemplary embodiment of the present invention may be represented by the following Chemical Formula 2:

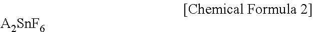

wherein
A is Na, K, or NH₄.

In addition, the germanium salt according to an exemplary embodiment may be represented by the following Chemical Formula 3:

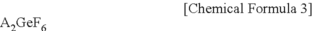

wherein
A is Li, Na, K, or NH₄.

In addition, the tin salt or the germanium salt according to an exemplary embodiment may be included at 0.01 to 1 wt %, preferably 0.01 to 0.5 wt %, and more preferably 0.01 to 0.1 wt %, based on the total amount of the electrolyte. Within the range, the non-aqueous electrolyte including the tin salt or the germanium salt may excellently form a coat, and also the salts may be dissolved well therein.

The tin salt or the germanium salt according to an exemplary embodiment of the present invention may excellently improve the performance of the secondary battery only with a very small amount of 0.1 wt % or less of the total amount of the electrolyte, and the secondary battery employing it may be very economical and effective.

The non-aqueous electrolyte for a secondary battery according to an exemplary embodiment may further include a silicon salt represented by the following Chemical Formula 4:

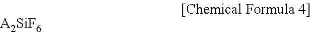

wherein
A is Li, Na, K, or NH₄.

The silicon salt may be included at 0.001 to 1 wt %, preferably 0.001 to 0.5 wt %, and more preferably 0.001 to 0.1 wt %, based on the total amount of the electrolyte.

In addition, a weight ratio of the tin salt or the germanium salt to the silicon salt according to an exemplary embodiment may be 1:0.01 to 1, specifically 1:0.1 to 0.8, and more specifically 1:0.2 to 0.6.

By further including the silicon salt in the non-aqueous electrolyte including the tin salt or the germanium salt, an effect of forming a protective membrane on the surface of the positive electrode material and the negative electrode material is further increased due to the synergy effect of different heterogeneous metal salts to improve high-temperature life characteristics and output characteristics much.

The electrolyte salt according to an exemplary embodiment of the present invention may be any lithium salt, and specifically, may be one or two or more selected from LiPF₆, LiBF₄, LiSbF₆, LiAsF₆, LiCF₃SO₃, LiC₄F₉SO₃, LiClO₄, LiAlCl₄, LiN(CₓF₂ₓ₊₁SO₂)₂ (x is an integer of 0 or more), LiCl, and LiI, and more specifically, may be one or two or more selected from LiPF₆, LiBF₄, (CF₃SO₂)₂NLi, and (C₂F₅SP₂)₂NLi, but is not particularly limited thereto. Excellent energy density, output characteristics, and lifespan may be shown from the secondary battery including the electrolyte salt as described above.

A concentration of the electrolyte salt according to an exemplary embodiment may be 0.5 to 3 mol/L, preferably 0.7 to 2.2 mol/L, and more preferably 0.9 to 2 mol/L. Within the range, it is possible to prevent degradation of cycle characteristics due to a decrease in ion conductivity of the secondary battery, and it is possible to prevent degradation of cycle characteristics due to an increase in viscosity.

The non-aqueous organic solvent according to an exemplary embodiment is not particularly limited, but may one or two or more selected from propylene carbonate, ethylene carbonate, butylene carbonate, diethyl carbonate, dimethyl carbonate, methyl ethyl carbonate, γ-butyrolactone, γ-valerolactone, ethyl acetate, methyl propionate, tetrahydrofuran, 2-methyltetrahydrofuran, dioxane, dimethoxyethane, diethyl ether, dimethyl sulfoxide, dimethyl sulfone, and sulfolane. Specifically, one or a mixture of two or more of carbonate-based solvents may be selected.

In the non-aqueous electrolyte for a secondary battery of the present invention, a commonly used additive may be added to an electrolyte at any ratio. An example of the additive may be one or two or more additives selected from cyclohexylbenzene, biphenyl, t-butylbenzene, vinylene carbonate, vinyl ethylene carbonate, difluoroanisole, fluoroethylene carbonate, propanesultone, dimethyl vinylene carbonate, and succinonitrile. The additive shows an effect such as overcharge prevention, negative electrode coat formation, and positive electrode protection. In addition, the non-aqueous electrolyte may be used after being solidified with a gelling agent or a crosslinking polymer, as in the case of being commonly used in a polymer battery using a non-aqueous electrolyte called a lithium polymer battery.

The present invention provides a secondary battery including: a first electrode; a second electrode; and the non-aqueous electrolyte for a secondary battery according to an exemplary embodiment interposed between the first electrode and the second electrode. The secondary battery employing the non-aqueous electrolyte including the tin salt or the germanium salt according to an exemplary embodiment of the present invention may suppress a deterioration phenomenon of the positive electrode material which may be caused by exposure to extreme conditions such as fast charge/discharge, high-temperature storage, and high-temperature charge/discharge, thereby showing significantly improved battery performance.

The first electrode and the second electrode according to an exemplary embodiment of the present invention may be a lithium electrode, and the secondary battery may be formed of an additional constituent member such as a current collector, a separator, and a container, in addition to a positive electrode as the first electrode, a negative electrode as the second electrode, and an electrolyte.

The material forming the positive electrode may be one or two or more selected from lithium-containing transition metal composite oxides such as LiCoO₂, LiNiO₂, LiNiₓCo_{y}Mn_{z}O₂ (x+y+z=1), and LiMn₂O₄; mixtures of the lithium-containing transition metal composite oxide and one or two or more of the transition metals; oxides in which a part of the transition metals of the lithium-containing transition metal composite oxide is substituted with a heterogeneous metal; and metal oxides such as V₂O₅ and MoO₃, sulfides such as TiS₂ and FeS, conductive polymers such as polyacetylene, polyparaphenylene, polyaniline, and polypyrrole, activated carbon, and polymers or carbon materials generating radicals, but is not limited thereto.

The material forming the negative electrode may be one or two or more selected from a lithium metal, silicon, an alloy of aluminum-lithium, an alloy of magnesium-lithium, intermetallic compound, artificial graphite, natural graphite, carbon materials, metal oxides, metal nitrides, activated carbon, and conductive polymers, which may adsorb and release lithium ions, but is not limited thereto.

As a material forming the positive electrode or the negative electrode, a conductive material such as acetylene black, ketjen black, carbon fiber, and graphite, and a binding agent such as polytetrafluoroethylene, polyvinylidene fluoride, and SBR resin may be further included.

The current collector according to an exemplary embodiment of the present invention may be one or two or more selected from copper, aluminum, stainless steel, titanium, silver, palladium, nickel, an alloy thereof, and a composite thereof, and other than that, activated carbon, a non-conductive polymer which is surface-treated with a conductive material, a conductive polymer, or the like may be used, but the current collector is not limited thereto.

As a method of applying the material forming the negative electrode and the positive electrode on the current collector, both a known method and a new method may be used, considering the characteristics of the material. For example, the material may be uniformly dispersed with a doctor blade and the like, and a method such as die casting, comma coating, and screen printing may be used.

In addition, conductive lead members for collecting current occurring in the positive electrode and the negative electrode when operating a battery and leading the current to a positive electrode terminal and a negative electrode terminal may be attached, respectively to the negative electrode or the positive electrode.

As the separator according to an exemplary embodiment, polypropylene, polyethylene, paper, non-woven fabric formed of glass fiber, porous sheets, or composites thereof may be used for preventing contact between the positive electrode and the negative electrode.

The secondary battery according to an exemplary embodiment of the present invention may be assembled into a battery showing a shape such as coin, cylindrical, angular, and aluminum laminate sheet shapes, but is not limited thereto.

Hereinafter, the non-aqueous electrolyte for a secondary battery including the tin salt or the germanium salt according to the present invention and the secondary battery employing the same will be described in more detail through the specific examples.

However, the following examples are only a reference for describing the present invention in detail, and the present invention is not limited thereto and may be implemented in various forms. In addition, the terms used herein are only for effectively describing certain examples and are not intended to limit the present invention.

### Example 1

94 parts by weight of NCM811 powder, 3 parts by weight of a polyvinylidene fluoride (PVDF) binder, and 3 parts by weight of a carbon conductive material were mixed into a paste form, applied on an aluminum foil, and dried at 150° C. for 12 hours, and then a NCM811 positive electrode body was manufactured.

91 parts by weight of graphite powder, 8 parts by weight of a PVDF binder, and 1 part by weight of Super-P (Timcal) were mixed into a slurry form, applied on a copper foil, and dried at 150° C. for 12 hours, and then a graphite negative electrode body was manufactured.

1.0 mol/L of LiPF₆ and 0.05 wt % of Na₂SnF₆ based on the total amount of the electrolyte were added to a mixed solvent of ethylene carbonate (EC) and ethyl methyl carbonate (EMC) (volume ratio=3:7) to prepare a non-aqueous electrolyte, and the non-aqueous electrolyte was allowed to permeate a polyethylene separator.

The NCM811 positive electrode body and the graphite negative electrode body were positioned so that they face each other, the polyethylene separator was interposed therebetween, and the non-aqueous electrolyte was injected to manufacture a battery with a stainless steel exterior.

### Example 2

A battery was manufactured in the same manner as in Example 1, except that (NH₄)₂SnF₆ was used instead of Na₂SnF₆.

### Example 3

A battery was manufactured in the same manner as in Example 1, except that (NH₄)₂GeF₆ was used instead of Na₂SnF₆.

### Example 4

A battery was manufactured in the same manner as in Example 1, except that Li₂GeF₆ was used instead of Na₂SnF₆.

### Example 5

94 parts by weight of NCM811 powder, 3 parts by weight of a polyvinylidene fluoride (PVDF) binder, and 3 parts by weight of a carbon conductive material were mixed into a paste form, applied on an aluminum foil, and dried at 150° C. for 12 hours, and then a NCM811 positive electrode body was manufactured.

91 parts by weight of graphite powder, 8 parts by weight of a PVDF binder, and 1 part by weight of Super-P (Timcal) were mixed into a slurry form, applied on a copper foil, and dried at 150° C. for 12 hours, and then a graphite negative electrode body was manufactured.

1.0 mol/L of LiPF₆ and 0.05 wt % of Na₂SnF₆ based on the total amount of the electrolyte were added to a mixed solvent of ethylene carbonate (EC) and ethyl methyl carbonate (EMC) (volume ratio=3:7) to prepare a non-aqueous electrolyte, and the non-aqueous electrolyte was allowed to permeate a polyethylene separator.

The NCM811 positive electrode bodies were positioned so that they face each other, the polyethylene separator was interposed therebetween, and the non-aqueous electrolyte was injected to manufacture a positive electrode symmetric cell with a stainless steel exterior.

The graphite negative electrode bodies were positioned so that they face each other, the polyethylene separator was interposed therebetween, and the non-aqueous electrolyte was injected to manufacture a negative electrode symmetric cell with a stainless steel exterior.

### Example 6

A positive electrode symmetric cell and a negative electrode symmetric cell were manufactured in the same manner as in Example 5, except that (NH₄)₂SnF₆ was used instead of Na₂SnF₆.

### Example 7

A positive electrode symmetric cell and a negative electrode symmetric cell were manufactured in the same manner as in Example 5, except that (NH₄)₂GeF₆ was used instead of Na₂SnF₆.

### Example 8

A positive electrode symmetric cell and a negative electrode symmetric cell were manufactured in the same manner as in Example 5, except that Li₂GeF₆ was used instead of Na₂SnF₆.

### Comparative Example 1

A battery was manufactured in the same manner as in Example 1, except that Na₂SnF₆ was not used.

### Comparative Example 2

A battery was manufactured in the same manner as in Example 1, except that 1.0 wt % of vinylene carbonate (VC) was used instead of 0.05 wt % of Na₂SnF₆.

### Comparative Example 3

A positive electrode symmetric cell and a negative electrode symmetric cell were manufactured in the same manner as in Example 5, except that Na₂SnF₆ was not used.

### Comparative Example 4

A positive electrode symmetric cell and a negative electrode symmetric cell were manufactured in the same manner as in Example 5, except that 1.0 wt % of vinylene carbonate (VC) was used instead of 0.05 wt % of Na₂SnF₆.

### [Experimental Example 1] Electrochemical Impedance Spectroscopic (EIS) Analysis

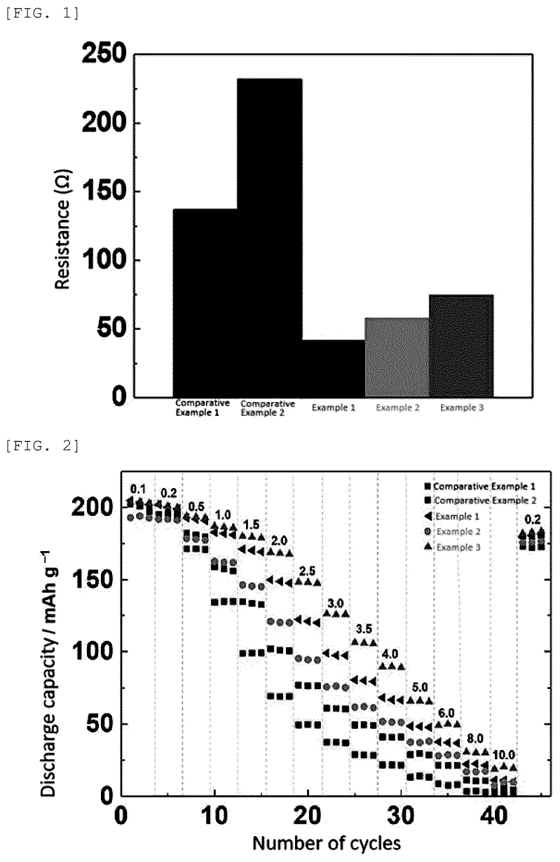

Examples 1 to 3 and Comparative Examples 1 and 2 were analyzed using an electrochemical impedance spectrometric (EIS) instrument in a range of 100 mHz to 1 MHz, and a Nyquist plot as the result is shown in FIG. 1. As shown in FIG. 1, it was confirmed that the batteries of Examples 1 to 3 of the present invention had much lower internal resistance than Comparative Examples 1 and 2, and thus, it was found that the examples of the present invention showed low resistance and significantly improved electrical properties.

### [Experimental Example 2] Evaluation of Output Characteristics

The output characteristics at room temperature (25° C.) of Examples 1 to 3 and Comparative Examples 1 and 2 were evaluated and are shown in FIG. 2. As shown in FIG. 2, the batteries of Examples 1 to 3 of the present invention and Comparative Examples 1 and 2 showed similar discharge capacities up to the current of 0.2 C, but the batteries of Examples 1 to 3 showed significantly higher discharge capacities at a high current of 0.5 to 10 C, and thus, it was found that the examples of the present invention showed excellent output characteristics.

### [Experimental Example 3] Evaluation of High-Temperature Life Characteristics

Examples 1 to 3 and Comparative Examples 1 and 2 were charged and discharged 3 times with a constant current of 0.1 C at room temperature (25° C.) in a range of 3-4.3 V, and then charged and discharged 200 times at 60° C., and the results are shown in Table 1.

As shown in Table 1, Examples 1 to 3 showed a discharge capacity of 140.4 mAh·g⁻¹ or more and a relatively high life retention rate of 71% or more even after charging and discharging 200 times. However, it was found that Comparative Examples 1 and 2 had rapidly lowered discharge capacities of 12.8 mAh·g⁻¹ and 102.6 mAhg⁻¹, respectively, after charging and discharging 200 times.

Thus, it was found that Examples 1 to 3 of the present invention showed significantly better high-temperature life characteristics than Comparative Examples 1 and 2, and in particular, the battery employing the electrolyte including the tin salt and the germanium salt of the present invention was a battery having excellent performance by having both improved high-temperature life characteristics and output characteristics as compared with Comparative Example 2 including VC as a conventional additive which showed somewhat improved high-temperature life characteristics but low output characteristics.

TABLE 1

| | | Charge/discharge at 60° C. | | |
|---|---|---|---|---|
| | | Discharge | Discharge | |
| | | capacity after | capacity after | Life |
| | | one cycle | 200 cycles | retention |
| | Additive | (mAh g⁻¹) | (mAh g⁻¹) | rate (%) |
| Example 1 | Na₂SnF₆ | 197.1 | 147.9 | 75.0 |
| Example 2 | (NH₄)₂SnF₆ | 201.2 | 142.9 | 71.0 |
| Example 3 | (NH₄)₂GeF₆ | 198.6 | 140.4 | 70.7 |
| Comparative | None | 182.3 | 12.8 | 7.0 |
| Example 1 | | | | |
| Comparative | VC | 190.4 | 102.6 | 53.9 |
| Example 2 | | | | |

### [Experimental Example 4] Evaluation of High-Temperature Life Characteristics of Symmetric Cell

Examples 5 to 7 and Comparative Examples 3 and 4 were first charged and discharged 3 times with a constant current of 0.1 C at room temperature (25° C.) in a range of 3-4.3 V, and then charged and discharged 200 times at 60° C., and the results are shown in Table 2.

As shown in Table 2, the positive electrode symmetric cells of Examples 5 to 7 showed a discharge capacity of 115.1 mAh·g⁻¹ or more and a higher life retention rate than that of Comparative Example 4 including VC as a conventional additive after charging and discharging 200 times. Comparative Examples 3 and 4 were found to have a significantly lowered discharge capacity of 72.0 mAhg⁻¹ and 98.7 mAhg⁻¹, respectively after charging and discharging 200 times.

Likewise, the negative electrode symmetric cells of Examples 5 to 7 also showed a discharge capacity of 133.4 mAh·g⁻¹ or more and a higher life retention rate than that of Comparative Example 4 including VC as a conventional additive, after charging and discharging 200 times. Comparative Examples 3 and 4 were found to have a significantly lowered discharge capacity of 38.9 mAhg⁻¹ and 111.8 mAhg⁻¹, respectively after charging and discharging 200 times.

Thus, it was found that the positive electrode and negative electrode symmetric cells of Examples 5 to 7 showed significantly better high-temperature life characteristics than the positive electrode and negative electrode symmetric cells of Comparative Examples 3 and 4.

TABLE 2

| | | Charge/discharge at 60° C. | | | Charge/discharge at 60° C. | | |
|---|---|---|---|---|---|---|---|
| | | (positive electrode | | | (negative electrode | | |
| | | symmetric cell) | | | symmetric cell) | | |
| | | Discharge | Discharge | | Discharge | Discharge | |
| | | capacity | capacity | | capacity | capacity | |
| | | after one | after 200 | Life | after one | after 200 | Life |
| | Electrolyte | cycle | cycles | retention | cycle | cycles | retention |
| | additive | (mAh g⁻¹) | (mAh g⁻¹) | rate (%) | (mAh g⁻¹) | (mAh g⁻¹) | rate (%) |
| Example 5 | Na₂SnF₆ | 215.6 | 115.1 | 53.4 | 328.1 | 133.4 | 40.7 |
| Example 6 | (NH₄)₂SnF₆ | 220.0 | 124.3 | 56.5 | 325.1 | 145.5 | 44.8 |
| Example 7 | (NH4)₂GeF₆ | 217.9 | 121.6 | 55.8 | 323.8 | 147.1 | 45.4 |
| Comparative | None | 207.8 | 72.0 | 34.6 | 302.8 | 38.9 | 12.8 |
| Example 3 | | | | | | | |
| Comparative | VC | 214.0 | 98.7 | 46.1 | 327.7 | 111.8 | 34.1 |
| Example 4 | | | | | | | |

From the above results, it was found that the electrolyte including the tin salt and the germanium salt of the present invention was dissolved in the non-aqueous solvent and formed a protective membrane on the surfaces of the positive electrode material and the negative electrode material, and thus, the secondary battery employing the electrolyte had a surprisingly improved deterioration phenomenon of the positive electrode material which may occur under extreme conditions and may be used as a very economical secondary battery which has very improved battery durability and shows excellent electrical properties.

Hereinabove, although the present invention has been described by specific matters, Examples, and Comparative Examples, they have been provided only for assisting in the entire understanding of the present invention. Therefore, the present invention is not limited to the above Examples.

Various modifications and changes may be made by those skilled in the art to which the present invention pertains from this description.

Therefore, the spirit of the present invention should not be limited to the above-described exemplary embodiments, and the following claims as well as all modifications equal or equivalent to the claims are intended to fall within the scope and spirit of the invention.

1. A non-aqueous electrolyte for a secondary battery comprising:
a tin salt or a germanium salt represented by the following Chemical Formula 1:
an electrolyte salt; and
a non-aqueous organic solvent: 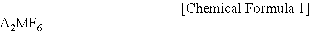
wherein
M is Sn or Ge; and
A is Li, Na, K, or NH₄.

2. The non-aqueous electrolyte for a secondary battery of claim 1, wherein the tin salt is represented by the following Chemical Formula 2: 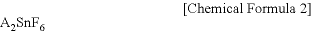
wherein
A is Na, K, or NH₄.

3. The non-aqueous electrolyte for a secondary battery of claim 1, wherein the germanium salt is represented by the following Chemical Formula 3: 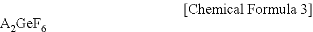
wherein
A is Li, Na, K, or NH₄.

4. The non-aqueous electrolyte for a secondary battery of claim 1, further comprising a silicon salt represented by the following Chemical Formula 4: 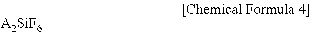
wherein
A is Li, Na, K, or NH₄.

5. The non-aqueous electrolyte for a secondary battery of claim 1, wherein the tin salt or the germanium salt is included at 0.01 to 1 wt % based on the total amount of the electrolyte.

6. The non-aqueous electrolyte for a secondary battery of claim 1, wherein the electrolyte salt is one or two or more selected from LiPF₆, LiBF₄, LiSbF₆, LiAsF₆, LiCF₃SO₃, LiC₄F₉SO₃, LiClO₄, LiAlCl₄, LiN(CₓF₂ₓ₊₁SO₂)₂ (x is an integer of 0 or more), LiCl, and LiI.

7. The non-aqueous electrolyte for a secondary battery of claim 1, wherein a concentration of the electrolyte salt is 0.5 to 3 mol/L.

8. The non-aqueous electrolyte for a secondary battery of claim 1, wherein the non-aqueous organic solvent is one or two or more selected from propylene carbonate, ethylene carbonate, butylene carbonate, diethyl carbonate, dimethyl carbonate, methyl ethyl carbonate, γ-butyrolactone, γ-valerolactone, ethyl acetate, methyl propionate, tetrahydrofuran, 2-methyltetrahydrofuran, dioxane, dimethoxyethane, diethyl ether, dimethyl sulfoxide, dimethyl sulfone, and sulfolane.

9. The non-aqueous electrolyte for a secondary battery of claim 1, wherein the non-aqueous electrolyte for a secondary battery further includes one or two or more additives selected from cyclohexylbenzene, biphenyl, t-butylbenzene, vinylene carbonate, vinyl ethylene carbonate, difluoroanisole, fluoroethylene carbonate, propanesultone, dimethyl vinylene carbonate, and succinonitrile.

10. A secondary battery comprising:
a first electrode;
a second electrode; and
the non-aqueous electrolyte for a secondary battery of claim 1 interposed between the first electrode and the second electrode.
